(19) United States
(12) Patent Application Publication
(10) Pub. No.: US 2014/0237078 A1
(43) Pub. Date: Aug. 21, 2014

(54) METHOD AND APPARATUS FOR MANAGING CONTENT STORAGE SUBSYSTEMS IN A COMMUNICATIONS NETWORK

(71) Applicant: INTERDIGITAL PATENT HOLDINGS INC., Wilmington, DE (US)

(72) Inventors: Osama Lotfallah, San Diego, CA (US); Hang Liu, North Potomac, MD (US); Milan Patel, Harrow Middlesex (GB); Xavier De Foy, Kirkland (CA); Kamel M. Shaheen, King of Prussia, PA (US)

(73) Assignee: INTERDIGITAL PATENT HOLDINGS, INC., Wilmington, DE (US)

(21) Appl. No.: 14/348,008

(22) PCT Filed: Sep. 28, 2012
(86) PCT No.: PCT/US2012/057971

§ 371 Date: Mar. 27, 2014

Related U.S. Application Data
(60) Provisional application No. 61/541,915, filed on Sep. 30, 2011.

(51) Int. Cl. H04L 29/06

(52) U.S. Cl. CPC H04L 65/4069
USPC 709/217

(57) ABSTRACT

A method and apparatus for managing content storage subsystems in a communications network are disclosed. The communications network is equipped with a plurality of content storage subsystems. The content storage subsystems store local copies of content to facilitate the delivery and distribution of the content to wireless transmit/receive units, WTRUs. The network, which is equipped with a proxy server and an entry server, receives requests for content or general-purpose data referencing content and determines whether the content is stored in the storage subsystems. In addition, the network also performs content ingestion in order to store copies of the content in the storage subsystems and content modification in order to move content from one storage location to another to achieve optimal content storage and distribution.

### CROSS REFERENCE TO RELATED APPLICATIONS

This application claims the benefit of U.S. Provisional Application No. 61/541,915 filed on Sep. 30, 2011, the contents of which are hereby incorporated by reference herein as if fully set forth.

### BACKGROUND

User demand for multimedia content over the Internet is increasing at a fast pace. The demand, which is typically due to user interest in large-sized multimedia content, is high enough to consume much of the bandwidth resources of networks, such as telecommunications carrier networks and Internet service provider (ISP) networks. To alleviate the strain placed on the networks, network operates equip networks with content storage subsystems, such as caching subsystems, that store copies of content and readily deliver the content to user devices.

However, the content storage subsystems may not achieve their full potential if they do not remain current and aware of user interest in the multimedia content. It is, therefore, desirable to have a method and apparatus to manage content storage subsystems in a communications network. It is also desirable for the communications network to be equipped to perform interception, content ingestion, and content modification.

### SUMMARY

A method and apparatus for facilitating delivery of content are provided. In the method and apparatus, a plurality of storage subsystems may be employed. An entry server may receive a request to ingest the content from a proxy server. In one embodiment, the entry server identifies a first storage subsystem of the plurality of storage subsystems, whereby the first storage subsystem is being tasked with storing the content. In another embodiment, the entry server sends a request for ingestion to the first storage subsystem. The first storage subsystem may receive the request for ingestion, receive the content from an origin server, and store the content.

In an embodiment, the origin server is outside the network. In another embodiment, the proxy server is may receive a request for content from a wireless transmit/receive unit (WTRU), and provide the content to the WTRU from the first storage subsystem.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2A shows a network employing a plurality of content storage subsystems;

FIG. 2B shows a network equipped to perform interception and content ingestion;

FIG. 3 shows a message flow for interception performed by a proxy server;

FIG. 4 shows a message flow for content ingestion performed in the network;

FIG. 5 shows a message flow for content modification;

FIG. 6 shows a method for ingestion and modification based on a content popularity metric;

FIG. 7 shows an Internet Protocol (IP) multimedia subsystem (IMS) network equipped to perform interception, content ingestion, and content modification; and

FIG. 8 shows a message flow of interception, content ingestion, and content modification in an IMS network.

### DETAILED DESCRIPTION

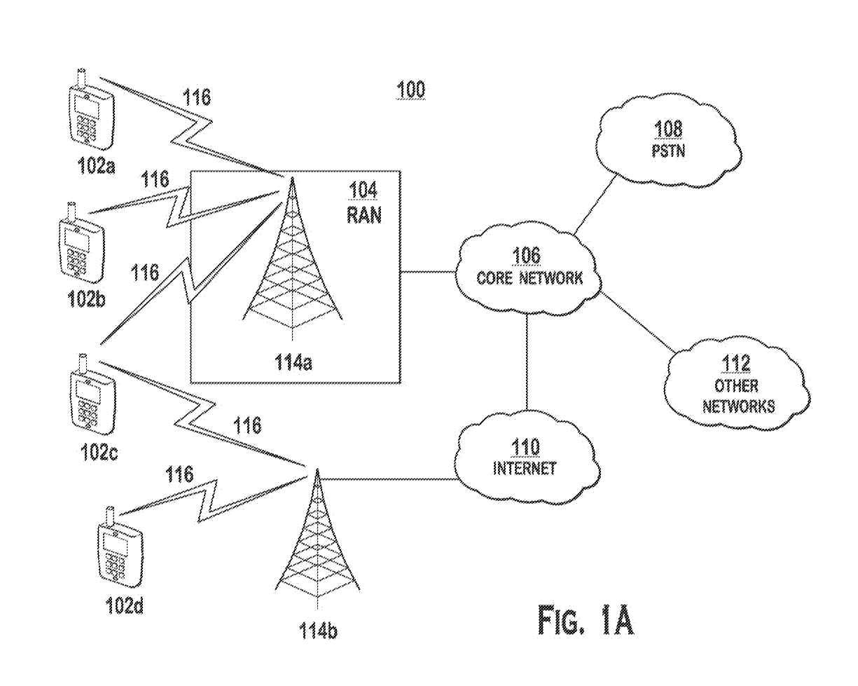

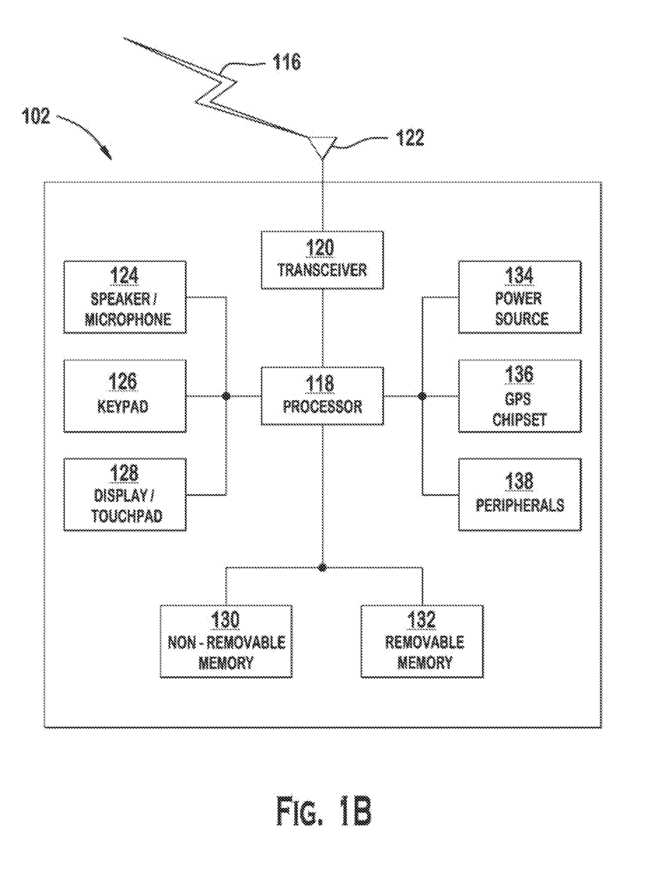

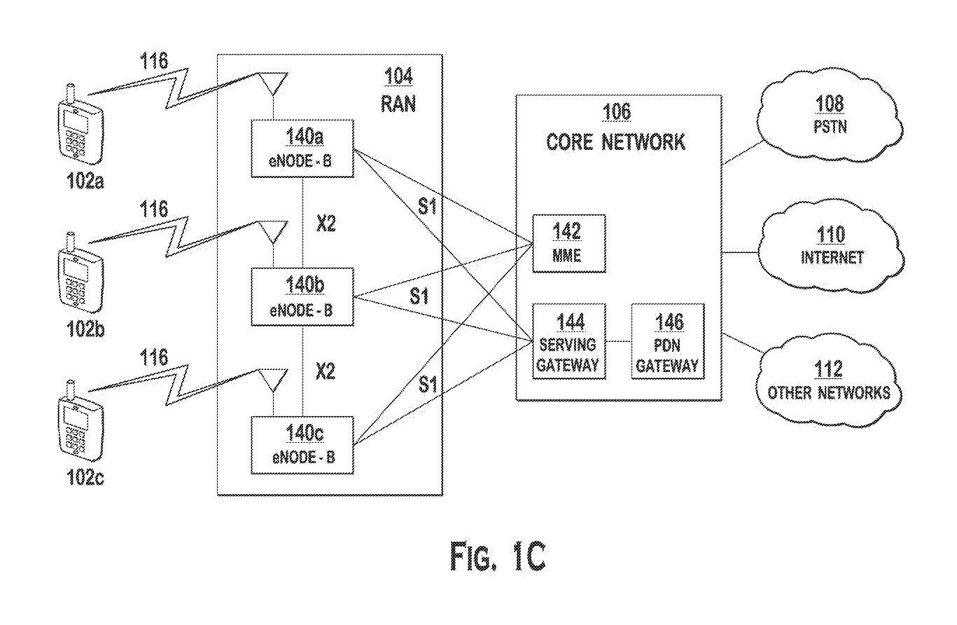

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

A WTRU, denoted herein as WTRU 102a, but may be any one of WTRUs 102b, 102c, or 102d, may connect to a network using any of a variety of access platforms. The network may be an internet service provider (ISP) network, a wireless operator network, a local network, an intranet, the Internet, or an IMS network. The access platforms include an evolved packet system (EPS) for LTE, GERAN, UMTS Terrestrial Radio Access Network (UTRAN), or any of the Institute for Electrical and Electronics Engineers (IEEE) 802 access platforms, among others.

It is noted that the term WTRU is not exclusively applied to devices configured to operate or communicate in a wireless environment, and the term includes devices configured to operate or communicate in a wired environment, such as a computer, or a smart television that is connected to the network using a wired connection.

Through network connectivity, the WTRU 102a is provided with the capability to receive content from the network. The content may be any media, such as text, audio, or video, or any multimedia. The content may be stored in a server and the network may deliver the content to the WTRU 102a. The server may be outside the network or alternatively, the server may be within the network or part of the network. Examples of the server include an origin server, which may be a server that the content creator uses to store the content and to facilitate the distribution of the content to the WTRU 102a. The WTRU 102a may request the content from the network and the network may deliver the content from the origin server to the WTRU 102a.

In order to facilitate content delivery to the WTRU 102a and alleviate network congestion that may arise due to high demand for content, the network may employ one or more content storage subsystems. Content storage subsystems are typically intended to reduce the network's reliance on the origin server as the source of the content and serve as an alternative source for the content. A content storage subsystem may, for example, store a local copy of the content within the network and enable providing the local copy of the content to the WTRU 102a more readily than the origin server. As such, the content storage subsystem enhances the network's content delivery capability and enables faster content distribution while reducing network traffic load.

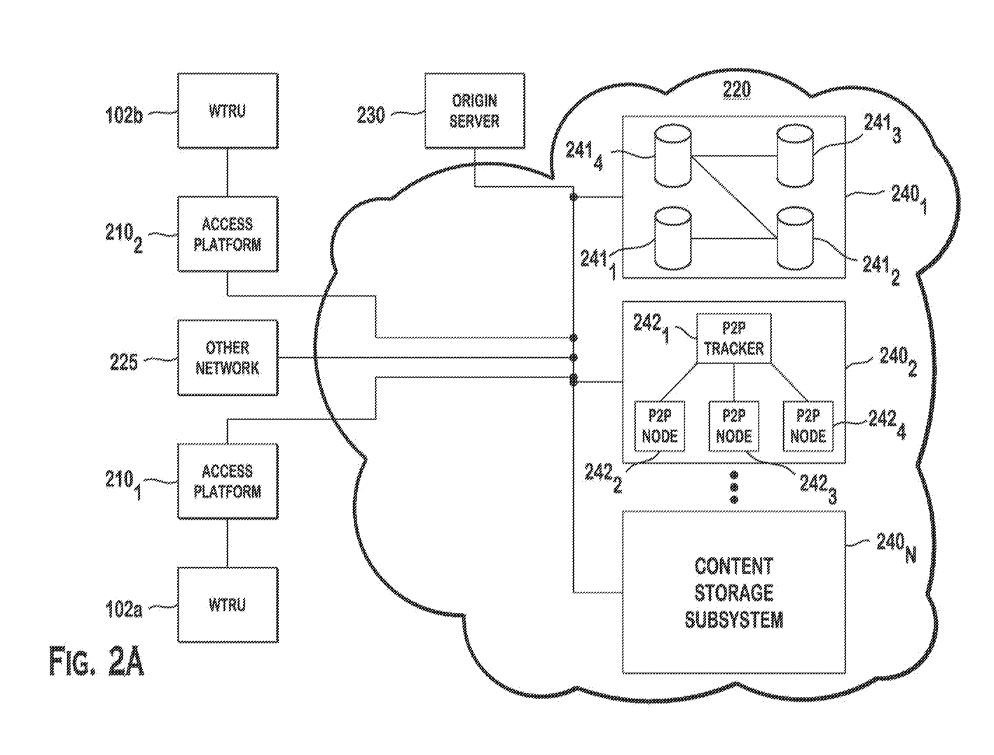

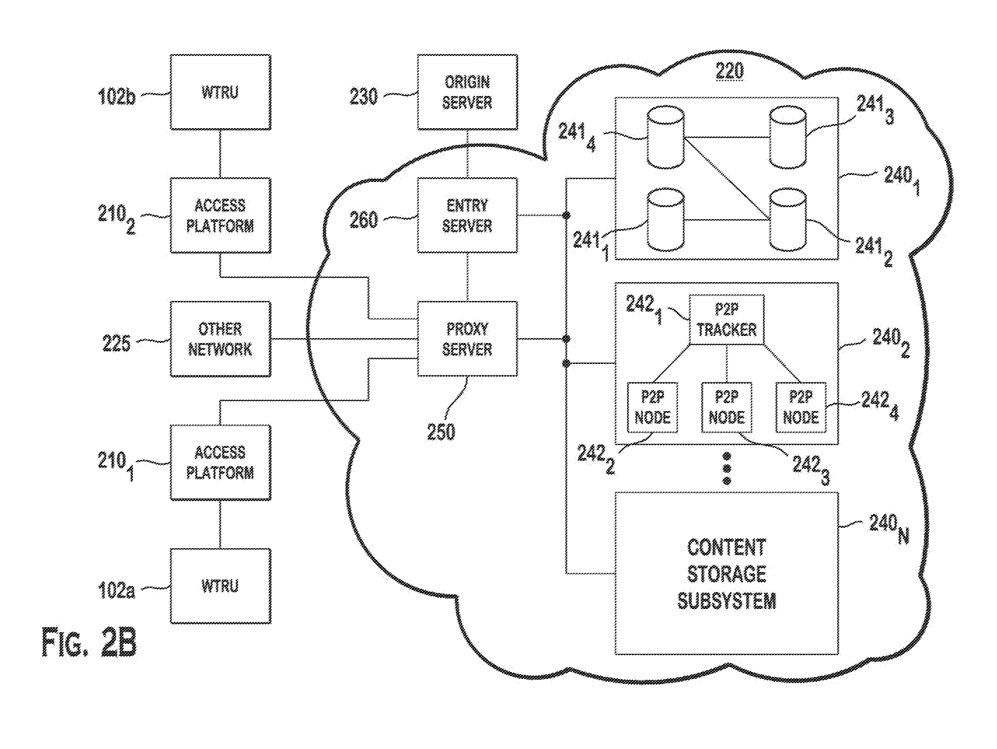

Examples of content storage subsystems include a caching subsystem and a peer-to-peer (P2P) subsystem, as described with reference to FIG. 2A.

FIG. 2A shows a network employing a plurality of content storage subsystems. The network 220 employs a plurality of content storage subsystems 240₁, 240₂, . . . , 240_{N} (collectively referred to hereinafter as storage subsystems 240_{1-N} and singularly referred to herein as storage subsystem 240). Of the content storage subsystems 240_{1-N}, the network 220 employs a caching subsystem 240₁ and a P2P subsystem 240₂. The network 220 is connected to an origin server 230. Further, WTRUs 102a, 102b are shown to be connected to the network 220 via access platforms 210₁, 210₂, respectively, as well as another network 225. The WTRUs 102a, 102b, or the other network 225 may request content from the network 220 (for example, by sending a request for content message or signal to the network 220) and the network 220 may fetch the content from the origin server 230 and provide the content to the WTRUs 102a, 102b, or the other network 225.

The caching subsystem 240₁ comprises a plurality of caching nodes 241₁₋₄ (singularly referred to hereinafter as caching node 241ᵢ). One or more copies of the content may be cached in a caching node 241ᵢ of the caching subsystem 240₁. The content may originate from origin server 230 and may be cached in a caching node 241ᵢ to facilitate content delivery. A caching node 241ᵢ may be in any location in the network 220 and the WTRUs 102a, 102b, or the other network 225 may be closer (in a network connectivity sense) to the caching node 241, than the origin server 230. Therefore, the content may be delivered more expeditiously and/or using fewer network resources to either WTRU 102a or WTRU 102b, or the other network 225 from the caching node 241ᵢ of the caching subsystem 240₁ than the origin server 230.

The P2P subsystem 242₂ comprises a P2P tracker 242₁ and a plurality of P2P nodes 242₂₋₄ (singularly referred to hereinafter as P2P node 242₂). The P2P node 242₂ stores content or portions of content, while the P2P tracker 242₁ maintains knowledge of where the content is stored or where portions of the content are stored. Although shown to be within the network 220 in FIG. 2A, a P2P node 242₂ may be outside the network 220. For example, WTRUs 102a, 102b may be a P2P node 242₂ and may store the entire content or a portion of the content and may provide the content to the network 220 upon request. The network 220 may determine the storage locations of the content based on information provided by the P2P tracker 242₁ and may request that the content be delivered to a party requesting the content.

A network 220 may receive a request for content and may perform interception in order to determine whether the content is stored in a storage subsystem 240ᵢ of the network 220. If the network 220 determines that the content is stored in the storage subsystem, then the network 220 may provide the content more readily from the storage subsystem 240ᵢ than an origin server 230 associated with the content.

However, if it is determined that the content is not stored in a storage subsystem 240ᵢ of the network 220, the network 220 may perform content ingestion in order to obtain and store the content in a storage subsystem 240ᵢ. After content ingestion, the network 220 may promptly provide the content to a requesting party, such WTRUs 102a, 102b, or the other network 225.

Interception may be performed by a proxy server of the network 220, whereas ingestion may be performed by an entry server of the network 220 as described with reference to FIG. 2B.

FIG. 2B shows a network equipped to perform interception and content ingestion. The network 220 is equipped with a proxy server 250, an entry server 260 and a plurality of storage subsystems 240_{1-N}, including a caching subsystem 240₁ and a P2P subsystem 240₂. WTRUs 102a, 102b are connected to the network 220 via access platforms 210₁, 210₂, respectively. Another network 225 is also connected to the network 220.

The proxy server 250 is equipped to perform interception (for example, using an interception interface), whereby the proxy server 250 may receive requests for content received from the WTRUs 102a, 102b or the other network 225 and determine whether the content is stored in the storage subsystems 240_{1-N}. If the content is stored in the storage subsystems 240_{1-N}, then the network may provide the content from the storage subsystems 240_{1-N}.

In addition to performing interception on requests for content, the proxy server 250 may also perform interception on any general-purpose data received from the WTRUs 102a, 102b or the other network 225. General-purpose data may, for example, be a text message received from WTRU 102a and intended for WTRU 102b. The general-purpose data may reference the content by link to the content or a uniform resource identifier (URI) associated with the content. The proxy server 250 may identify any content referenced in the general-purpose data by the URI of the content, for example. References to content in the general-purpose data may serve to indicate interest in content and may also serve to indicate a likelihood for a future request for the content due the interest in the content.

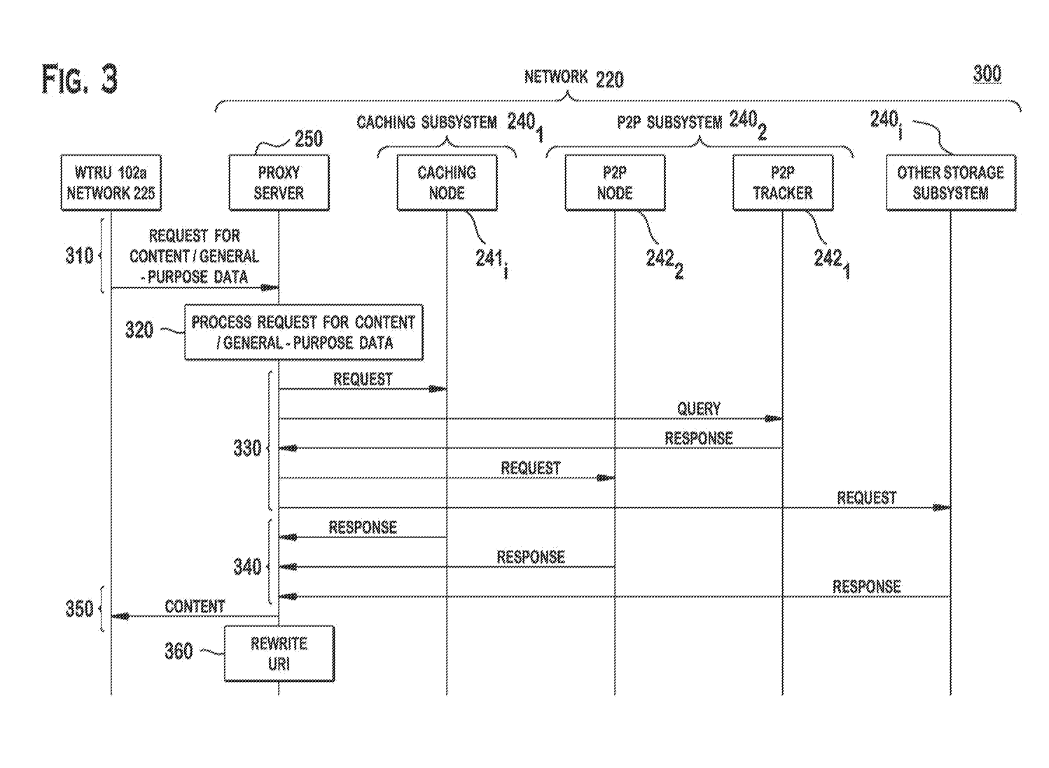

FIG. 3 shows a message flow for interception performed by a proxy server. In the message flow 300, the proxy server 250 receives a request for content or general-purpose data 310 from WTRUs 102a, 102b or network 225. The request for content or general-purpose data 310 may also be received from an application function (AF). The general-purpose data may, for example, be a message from WTRU 102a to WTRU 102b providing a link to the content. The general-purpose data may include a URI of the content.

The proxy server 250 processes the request for content or the general-purpose data 320, whereby the proxy server 250 identifies requested or referenced content and determines whether the content is stored in the storage subsystems 240_{1-N}.

The proxy server 250 then requests the content from the storage subsystems 240_{1-N} 330. For the caching subsystem 240₁, the proxy server 250 sends a request for content to a caching node 241ᵢ of the caching subsystem 240₁ 330. For the P2P subsystem 240₂, the proxy server 250 sends a query to P2P tracker 242₁ of the P2P subsystem 240₂330. The P2P tracker 242₁ responds to the query and if the response indicates that the content is stored in a P2P node 242₂ of the P2P subsystem 240₂, then the proxy server 250 sends a request for content to the P2P node 242₂ 330. The proxy server 250 also sends a request for content to any other storage subsystem 240₁ of the network 220 330. The request for content 330 may be a query as to whether the content is stored in the storage subsystem 240ᵢ.

The proxy server 250 receives responses from the storage subsystems 240_{1-N} 340. The responses 340 may provide the content to the proxy server, indicate that the content is stored, or provide a URI associated with the content that is stored in the storage subsystem 240ᵢ.

In the event that the proxy server 250 received a request for content from WTRUs 102a, 102b or network 225, then the proxy server 250 provides the content to the WTRUs 102a, 102b or network 225 350. If, however, the proxy server 250 intercepted general-purpose data, then the proxy server 250 may perform URI rewrite 360. When performing URI rewrite 360, the proxy server 250 replaces the URI of the content in the general-purpose data with a URI associated with content stored in the storage subsystem 240ᵢ. The proxy server 250 may then send the general-purpose data with the rewritten URI to its intended party (not shown). The intended may then request the content based on the rewritten URI.

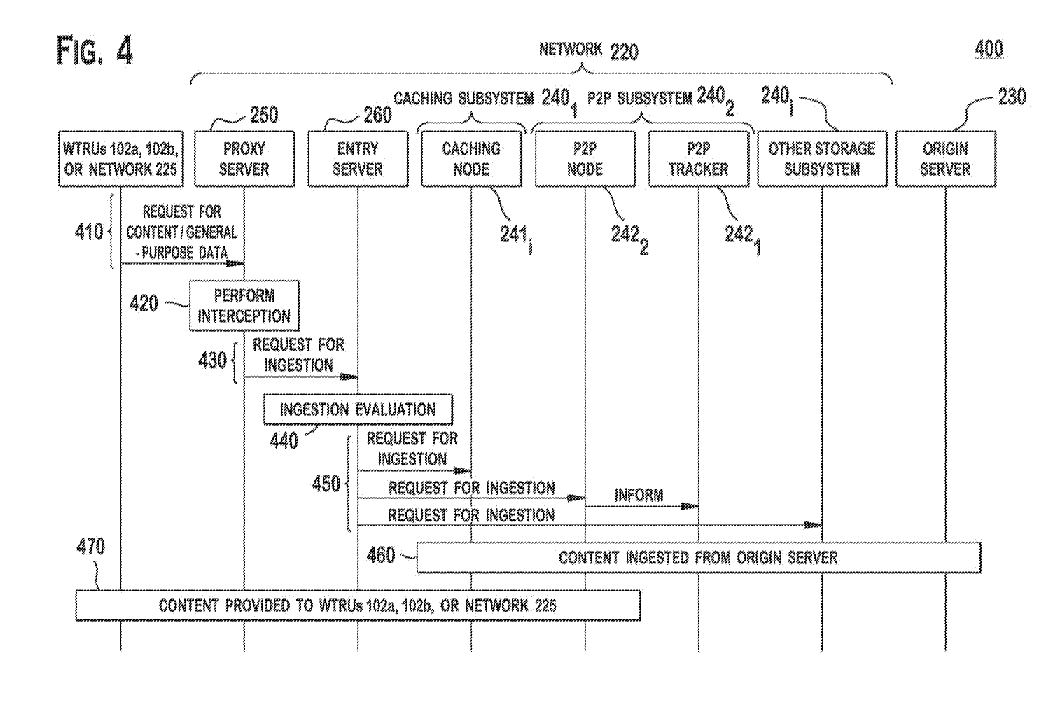

In the event that during interception it is determined that the content is not stored in the storage subsystems 240_{1-N} of the network, the network 220 may perform content ingestion in order to obtain the content and store the content in a storage subsystem 240ᵢ. Content ingestion allows the network to proactively store content that may be of interest (i.e., likely to be requested) by WTRUs 102a, 102b or network 225. The entry server 260 of the network 220 may be used to perform ingestion as described with reference to FIG. 4.

FIG. 4 shows a message flow for content ingestion performed in the network 220. In the message flow 400, the proxy server 250 receives a request for content or any general-purpose data 410 from WTRUs 102a, 102b or the other network 225. The request for content or general-purpose data 410 may also be received from an application function (AF). The proxy server 250 performs interception 420 (as described with reference to numerals 320-340 in FIG. 3, for example) and based on the interception, the proxy server 250 determines that the content is not stored in the storage subsystems 240_{1-N}. Accordingly, the proxy server determines that content ingestion is to be performed in order to store a copy of the content in a storage subsystem 240ᵢ of the network 220.

The proxy server 250 sends a request for ingestion 430 to the entry server 260. The request for ingestion 430 may indicate a URI of the content or the request for ingestion 430 may be a forwarded copy of the request for content or the general-purpose data 410. The entry server 260 performs ingestion evaluation 440 by which the entry server 260 determines which of the storage subsystems 240_{1-N} is to be designated to store the content once ingested. A content popularity metric may be used to perform ingestion evaluation 440 as will be described herein. The entry server 260 may perform ingestion using, for example, an ingestion interface.

After the ingestion evaluation 440, the entry server 260 sends a request for ingestion to a storage subsystems 240ᵢ 450. The request for ingestion 450 requests the storage subsystems 240ᵢ to store the content. In the case of the caching subsystem 240₁, the entry server 260 sends the request for ingestion to a caching node 241ᵢ of the caching subsystem 240₁, and in the case of the P2P subsystem 240₂, the entry server 260 sends the request for ingestion to a P2P node 242₂, which informs the P2P tracker 242₁ that the content is to be stored in the P2P node 242₂.

The content is then ingested from the origin server 230 to the storage subsystem 240ᵢ 460. Further, and if applicable, the content is provided from the storage subsystem 240ᵢ to WTRUs 102a, 102b or network 225 upon request 470.

In some embodiments, a storage subsystem, for example, a caching subsystem 240₁, may be able to provide content more readily than another storage subsystem, for example, a P2P subsystem 240₂. Accordingly, if content is popular then it is advantageous to store the content in the caching subsystem 240₁ so as to facilitate expedient delivery of the content to a larger number of WTRUs 102a, 102b, or another network 225 using less network resources. However, if the popularity of the content is low, then it is advantageous to store the content in the P2P subsystem 240₂ so as to reserve the storage resource of the caching subsystem 240₁ to more popular content.

The network 220 may also perform content modification. Content modification enables the network 220 to manage the storage of content across the network's storage subsystems 240_{1-N} in order to optimize the utilization of resources for content storage and delivery. For example, with content modification, the network may move content between two or more storage subsystems based on the content's popularity, whereby as content increases in popularity, the content is moved from a less readily accessible storage subsystem to a more readily accessible storage subsystem and vice-versa

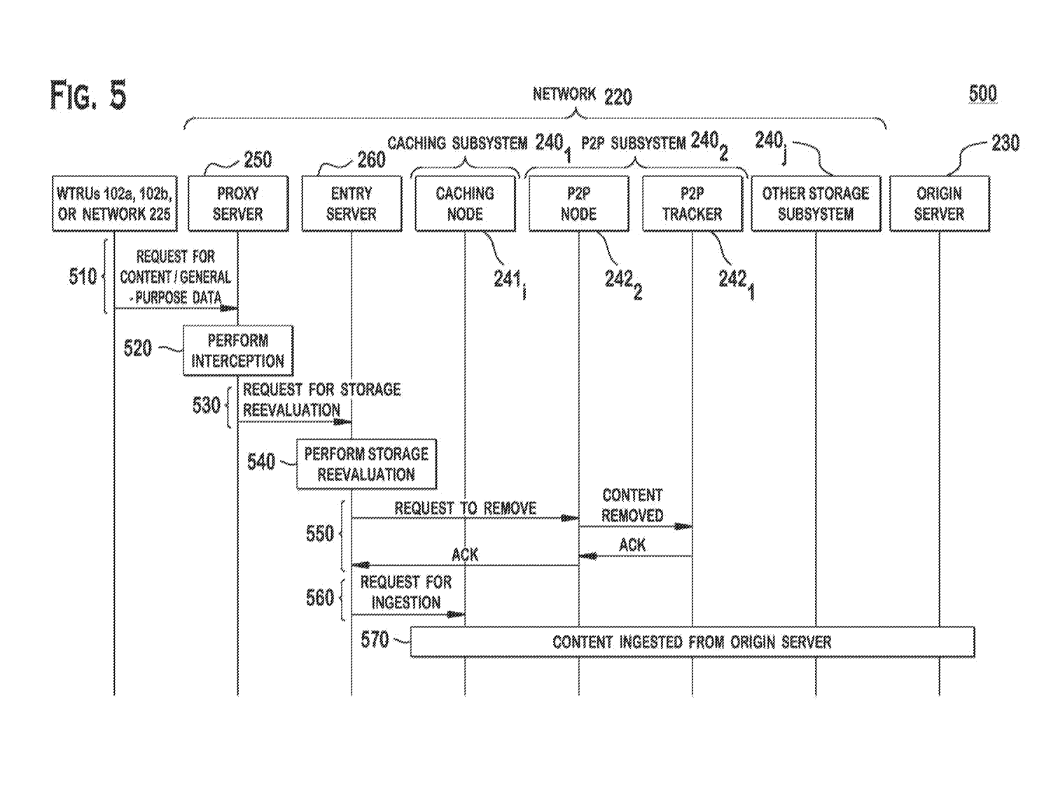

The entry server 260 may perform content modification (for example, using a modification interface) as described with reference to FIG. 5.

FIG. 5 shows a message flow for content modification. In the message flow 500, the proxy server 250 receives a request for content or general-purpose data 510 from WTRUs 102a, 102b or the other network 225. The request for content or general-purpose data 510 may also be received from an application function (AF). The proxy server 250 performs interception 520 (as described with reference to numerals 320-340 in FIG. 3, for example) and based on the interception, the proxy server 250 determines that the content is stored in a storage subsystem 240₁ of the network 220. In FIG. 5, the content is stored in the P2P subsystem 240₂, however, any other storage subsystem 240ᵢ may be contemplated. The proxy server seeks to determine whether storing the content in the P2P subsystem 240₂ is optimal, and if not, whether the content ought to be moved to another storage system, such as caching subsystem 240₁.

The proxy server 250 sends a request for storage reevaluation 530 to the entry server 260. It is noted that the proxy server 250 may be configured to send the request for storage reevaluation 530 periodically or every predetermined number of times the content is requested.

The entry server 260 performs storage reevaluation 540, whereby the entry server 260 determines whether the content is stored in an optimal subsystem, and if not, then the entry sever 260 causes the content to be removed from the P2P subsystem 240₂ and to be stored in a different storage subsystem 240_{1,3-N}. Storage reevaluation 530 may be performed based on content popularity.

As shown in FIG. 5, the entry server 260 determines that the content ought to be moved to the caching subsystem 240₁. The entry server removes the content from the P2P subsystem 240₁ 550. To do so, the entry server 260 sends a request to remove the content to the P2P subsystem 240₁. The request to remove is received by a P2P node 242₂. The P2P node 242₂ removes the content from the P2P node's 242₂ storage and informs the P2P tracker 242₁ that the content is removed. The P2P tracker 242₁ acknowledges the removal to the P2P node 242₂, and similarly the P2P node 242₂ acknowledges the removal to the entry server 260.

Following the removal of the content from the P2P subsystem 240₁, the entry server 260 sends a request for ingestion to the caching subsystem 240₁ 560. The request for ingestion is received by a caching node 241ᵢ of the caching subsystem 240₁ and content is then ingested from the origin server 230 to the caching node 241ᵢ of the caching subsystem 240₁ 570. It is noted that in some embodiments the order of content removal and content ingestion may be changed or reversed. For example, the entry server 260 may first send a request for ingestion 560 to the caching subsystem 240₁ and then send a request to remove 550 to the P2P subsystem 240₁ 550.

In an embodiment, content stored in a first storage subsystem (referred to herein as first storage subsystem 240ⱼ) may be provided more readily than content stored in a second storage subsystem (referred to herein as second storage subsystem 240ₖ). Further, a popularity metric, denoted p, may indicate a popularity associated with the content, where the popularity metric is proportional to the popularity associated with the content.

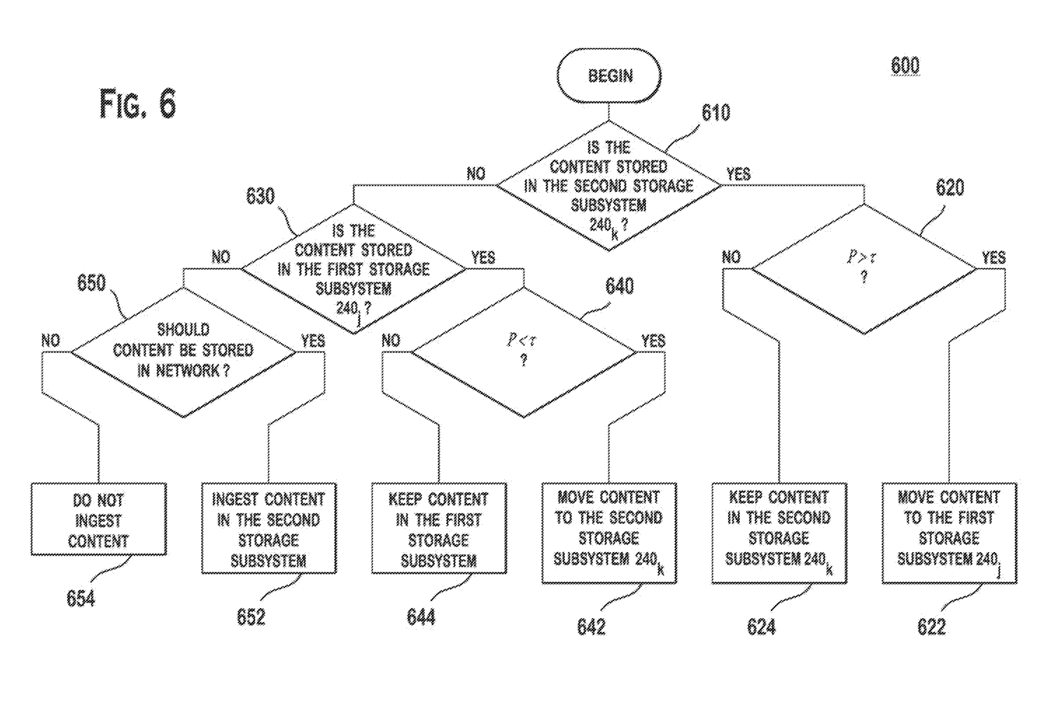

It is desirable for content associated with a high popularity metric to be stored in the first storage subsystem 240ⱼ because the content may be provided more readily to a larger number of WTRUs or networks from the first storage subsystem 240ⱼ. Conversely, content associated with a lower popularity metric is stored in the second storage subsystem 240k. As such, the content may be provided more readily to a larger number of WTRUs or networks. A threshold for the popularity metric, denoted τ, may be set, whereby content having a popularity metric higher than τ (i.e., more popular content) may be required to be stored in the first storage subsystem 240ⱼ, whereas content having a popularity metric lower than τ (i.e., less popular content) may be required to be stored in the second storage subsystem 240ₖ. As the content popularity metric changes, content may be moved between the first storage subsystem 240ⱼ and the second storage subsystem 240k as described with reference to FIG. 6.

FIG. 6 shows a method for ingestion and modification based on a content popularity metric. In the method 600, it is determined whether the content is stored in the second storage subsystem 240k 610. If the content is stored in the second storage subsystem 240k, then it is determined whether the popularity metric associated with the content, ρ, is greater than the threshold, τ, 620. If a positive determination is made, then the content is moved to the first storage subsystem 240ⱼ 622, and if a negative determination is made, then the content is kept in the second storage subsystem 240k 624.

If, however, it is determined that the content is not stored in the second storage subsystem 240k, then a determination is made as to whether the content is stored in the first storage subsystem 240ⱼ 630. If it is determined that the content is stored in the first storage subsystem 240ⱼ, then it is determined whether the popularity metric associated with the content is less than τ 640. If a positive determination is made, then the content is moved to the second storage subsystem 240k 642, and if a negative determination is made, then the content is kept in the first storage subsystem 240ⱼ 644.

At 630 if it is determined that the content is not stored in the first storage subsystem 240ⱼ, then a determination is made as to whether the content should be stored in the network 650. If a positive determination is made, then the content is ingested in the second storage subsystem 240k 652, and if a negative determination is made, then the content is not ingested in network 654 and the content is retrieved from an origin server 230 when requested.

It is noted that the threshold, τ, may change over time and independently of requests for content received (for example, in an observation period). Further, the threshold may be configured with a hysteresis, whereby the threshold for moving the content from first storage subsystem 240ⱼ to the second storage subsystem 240k may be set to τ=τ₁, whereas the threshold for moving the content from the second storage subsystem 240k to the first storage subsystem 240ⱼ may be set to τ=τ₂ with τ₁ being different than τ₂.

In an embodiment, the network 220 may be an IP multimedia subsystem (IMS) network. The IMS network provides architecture and framework for enabling the convergence of media and network technology over an IP-based infrastructure. The IMS network may be equipped to perform interception, content ingestion, and content modification as described herein.

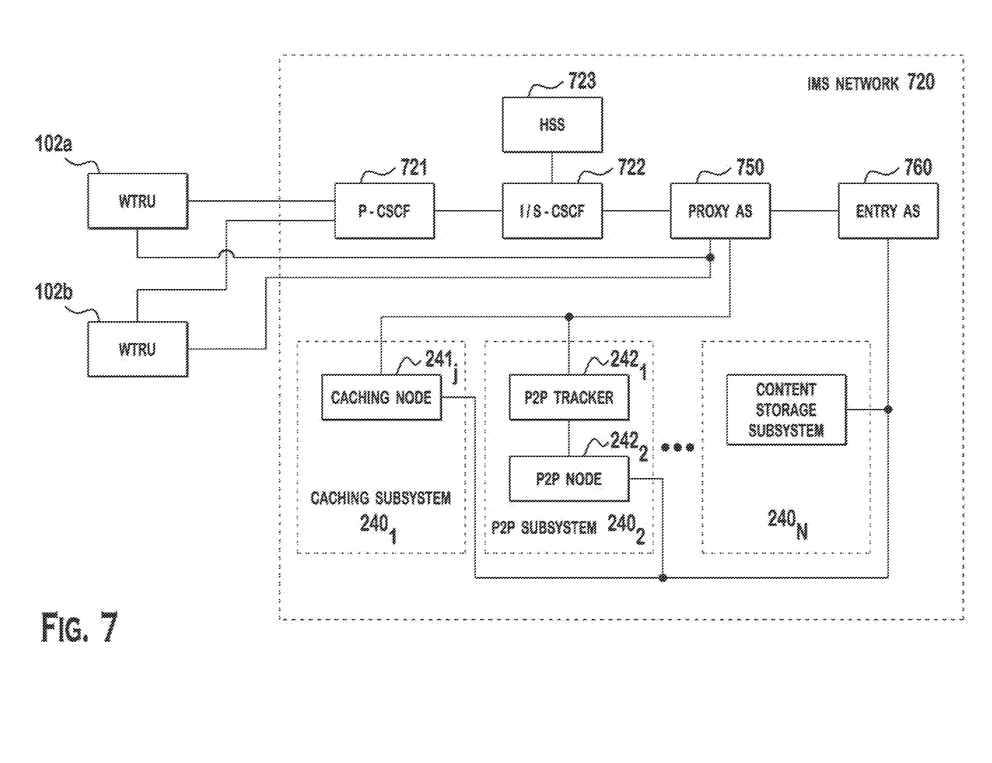

FIG. 7 shows an IMS network equipped to perform interception, content ingestion, and content modification. WTRUs 102a, 102b are connected to the IMS network 720. The IMS network 720 comprises a proxy call session control function (P-CSCF) 721, an interrogating and serving CSCF (I/S-CSCF) 722, and a home subscriber server (HSS). The IMS network 720 also comprises a proxy application server (AS) 750 equipped to perform interception and an entry AS 760 equipped to perform content ingestion and modification. The proxy AS 750 and the entry AS 760 may perform similar functions as the proxy server 250 and the entry server 260, respectively, described with reference to FIGS. 2-5.

The IMS network 720 is also equipped with a plurality of storage subsystems 240_{1-N}. Of the storage subsystems 240_{1-N}, the IMS network 720 includes a caching subsystem 240₁ and a P2P subsystem 240₂. The caching subsystem 240₁ comprises a caching node 241ᵢ, and the P2P subsystem 242₂ comprises a P2P tracker 242₁ and a P2P node 242₂.

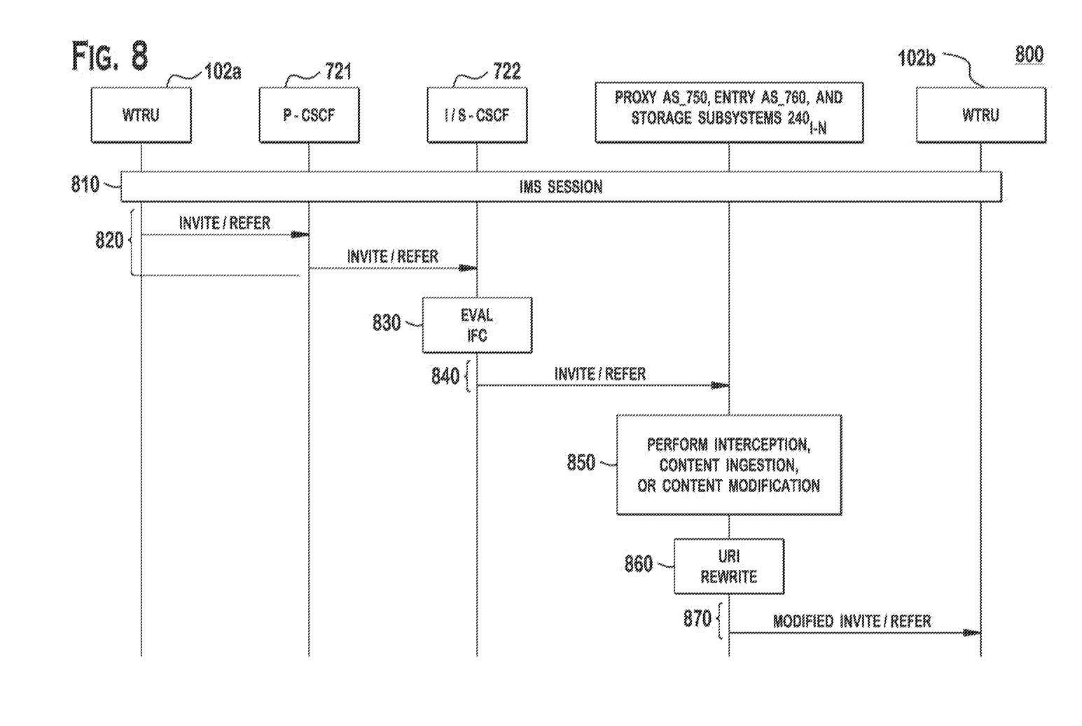

The IMS network 720 utilizes session initiation protocol (SIP) messaging and the P-CSCF 721 may receive SIP messages requesting content or having any general-purpose data from the WTRUs 102a, 102b. The P-CSCF 721 may forward the SIP messages within the network 720 where interception, content ingestion, and content modification may be performed as described with reference to FIG. 8.

FIG. 8 shows a message flow of interception, content ingestion, and content modification in an IMS network. The WTRUs 102a, 102b are engaged in an IMS session 810. The IMS session may be any media session. WTRU 102a sends a SIP INVITE/REFER message to WTRU 102b including a URI for content. The SIP INVITE/REFER message is received by the P-CSCF 721 and forwarded to the I/S-CSCF 722 820. The I/S-CSCF 722 applies an initial filter criteria (iFC) 830 and determines that the SIP INVITE/REFER message includes a URI. The I/S-CSCF 722 then sends the SIP INVITE/REFER message to the proxy AS 750 840.

Interception, content ingestion, and content modification are performed by the proxy AS 750, entry AS 760, or storage subsystems 240_{1-N} 850 as described with reference to numerals 320-340 of FIG. 3, numerals 420-460 of FIG. 4, or numerals 520-570 of FIG. 5. If proxy AS 750 determines that a storage subsystem 240ᵢ stores a copy of the content, the proxy AS 750 performs URI rewrite 860. The proxy AS 750 sends a modified INVITE/REFER message to WTRU 102b 870. The modified INVITE/REFER message includes a URI of content stored by a storage subsystem 240₁ as rewritten by proxy AS 750. The WTRU 102b may then request and receive the content based on the URI rewritten by the proxy AS 750 870.

It is noted that at any time in the message flow 800, acknowledgements, provisional acknowledgements or session progress updates may be sent or received by any element of the IMS network 720. Further, any element of the IMS network may be included in a messaging path by inserting “Record-Route” field addresses to the element in a SIP message. Further, the element may be included in a messaging path by adding the element's IP address in HSS records.

### EMBODIMENTS

1. A network for facilitating delivery of content.

2. The network of embodiment 1 comprising: a plurality of storage subsystems.

3. The network as in any one of the preceding embodiments comprising: an entry server.

4. The network as in any one of the preceding embodiments wherein the entry server is configured to receive, from a proxy server, a request to ingest the content.

5. The network as in any one of the preceding embodiments wherein the entry server is configured to identify a first storage subsystem of the plurality of storage subsystems for storing the content.

6. The network as in any one of the preceding embodiments wherein the entry server is configured to send a request for ingestion to the first storage subsystem.

7. The network as in any one of the preceding embodiments wherein the first storage subsystem is configured to receive the request for ingestion.

8. The network as in any one of the preceding embodiments wherein the first storage subsystem is configured to receive the content from an origin server.

9. The network as in any one of the preceding embodiments wherein the first storage subsystem is configured to store the content.

10. The network as in any one of the preceding embodiments wherein the origin server is outside the network.

11. The network as in any one of the preceding embodiments wherein the proxy server is configured to receive a request for the content from a wireless transmit/receive unit (WTRU).

12. The network as in any one of the preceding embodiments wherein the proxy server is configured to provide the content to the WTRU, wherein the content is stored in the first storage subsystem.

13. The network as in any one of the preceding embodiments wherein identifying the first storage subsystem is based on a popularity associated with the content.

14. The network as in any one of the preceding embodiments wherein the plurality of storage subsystems comprise a second storage subsystem.

15. The network as in any one of the preceding embodiments wherein the entry server is configured to receive a request for storage reevaluation from the proxy server.

16. The network as in any one of the preceding embodiments wherein the entry server is configured to determine whether to move the content from the first storage subsystem to a second storage subsystem of the plurality of storage subsystem based on a popularity associated with the content.

17. The network as in any one of the preceding embodiments wherein the first storage subsystem is able to provide the content to a wireless transmit/receive unit (WTRU) more readily than the second storage subsystem.

18. The network as in any one of the preceding embodiments wherein on a condition that a popularity associated with the content decreases below a threshold, the entry server is further configured to move the content to the second storage subsystem.

19. The network as in any one of the preceding embodiments wherein the first storage subsystem is able to provide the content to a wireless transmit/receive unit (WTRU) less readily than the second storage subsystem.

20. The network as in any one of the preceding embodiments wherein on a condition that a popularity associated with the content increases above a threshold, the entry server is further configured to move the content to the second storage subsystem.

21. The network as in any one of the preceding embodiments wherein the first storage subsystem is a caching subsystem.

22. The network as in any one of the preceding embodiments wherein the second storage subsystem is a P2P subsystem.

23. A network for facilitating delivery of content.

24. The network as in embodiment 23 comprising: a first storage subsystem; a second storage subsystem; and an entry server configured to receive a request for ingestion of the content.

25. The network as in any one of embodiments 23 and 24 wherein the entry server further configured to determine to store the content in one of the first storage subsystem or the second storage subsystem based on a popularity associated with the content.

26. The network as in any one of embodiments 23-25 wherein the first storage subsystem is capable of providing the content to a wireless transmit/receive unit (WTRU) more readily than the second storage subsystem.

27. The network as in any one of embodiments 23-26 wherein on a condition that the popularity associated with the content is greater than a threshold, the entry server is further configured to determine to store the content in the first storage subsystem.

28. The network as in any one of the preceding embodiments comprising an interception interface.

29. The network as in any one of the preceding embodiments comprising an ingestion interface.

30. The network as in any one of the preceding embodiments comprising a modification interface.

31. The network as in any one of the preceding embodiments wherein the network is an IMS.

32. The network as in any one of the preceding embodiments comprising: performing interception on any general-purpose data received.

33. The network as in any one of the preceding embodiments wherein the general-purpose data references content by link to the content or a uniform resource identifier (URI) associated with the content.

34. The network as in any one of the preceding embodiments wherein the proxy server identifies any content referenced in the general-purpose data by the URI of the content.

35. The network as in any one of the preceding embodiments wherein reference to content in the general-purpose data serves to indicate interest in content and a likelihood for a future request for the content due the interest in the content.

36. The network as in any one of the preceding embodiments wherein the request for content or general-purpose data is received from an application function (AF).

37. The network as in any one of the preceding embodiments comprising: performing URI rewrite.

38. The network as in any one of the preceding embodiments wherein the URI of the content in the general-purpose data is replaced with a URI associated with content stored in the storage subsystem.

39. The network as in any one of the preceding embodiments comprising: sending, by the proxy server, the general-purpose data with the rewritten URI to an intended party.

40. The network as in any one of the preceding embodiments comprising: receiving a request for content based on the rewritten URI.

41. An IMS network for performing interception, content ingestion, and content modification.

42. The network as in embodiment 41 comprising a P-CSCF, an I/S-CSCF, and an HSS.

43. The network as in any one of embodiments 41 and 42 comprising: a proxy AS equipped to perform interception and an entry AS equipped to perform content ingestion and modification.

44. The network as in any one of embodiments 41-43 comprising: receiving, by the P-CSCF, a SIP message requesting content or having any general-purpose data from a WTRU.

45. The network as in any one of embodiments 41-44 comprising: forwarding, by the P-CSCF, the SIP message for interception, content ingestion, and content modification to be performed.

46. The network as in any one of embodiments 41-45 wherein the SIP message is a SIP INVITE or REFER message.

47. The network as in any one of embodiments 41-46 wherein the SIP message includes a URI for content.

48. A proxy server for facilitating delivery of content.

49. The proxy server as in embodiment 48 configured to receive a request for content from a wireless transmit/receive unit (WTRU).

50. The proxy server as in any one of embodiments 48 and 49 further configured to determine whether the content is stored in a storage subsystem and on a condition that the content stored in the storage subsystem, the proxy server is configured to provide the content to the WTRU, and on a condition that the content is not stored in the storage subsystem, the proxy server is configured to send a request for ingestion of the content to an entry server.

51. The proxy server as in any one of embodiments 48-50 further configured to intercept general-purpose data sent by the WTRU.

52. The proxy server as in any one of embodiments 48-51 further configured to send a request for storage reevaluation to an entry server.

53. A wireless transmit/receive unit (WTRU) comprising a transmitter configured to transmit a request for content; and a receiver configured to receive the content, wherein the content is retrieved for the WTRU from an origin server or at least one storage subsystem of a plurality of storage subsystems based on a feature associated with the content.

54. The WTRU as in embodiment 53 wherein the feature associated with the content is a popularity of the content.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A network for facilitating delivery of content, the network comprising:
a plurality of storage subsystems including a first storage subsystem utilizing a first technology and a second storage subsystem utilizing a second technology; and
an entry server configured to:
receive, from a proxy server, a request to ingest the content;
identify a first storage subsystem of the plurality of storage subsystems for storing the content based on an attribute associated with the content;
send a request for ingestion to the first storage subsystem; and
the first storage subsystem configured to:
receive the request for ingestion;
receive the content from an origin server; and
store the content,
wherein ingestion to the first storage subsystem adjusts the storage of the content within the plurality of storage subsystems to the second storage subsystem using an attribute associated with the content.

2. The network of claim 1, wherein the origin server is outside the network.

3. The network of claim 1, wherein the proxy server is configured to:
receive a request for content from a wireless transmit/receive unit (WTRU); and
provide the content to the WTRU, wherein the content is stored in the first storage subsystem.

4. (canceled)

5. (canceled)

6. The network of claim 1, wherein the entry server is further configured to:
receive a request for storage reevaluation from the proxy server; and
determine whether to move the content from the first storage subsystem to a second storage subsystem of the plurality of storage subsystem based on a popularity associated with the content.

7. The network of claim 1, wherein the first storage subsystem is able to provide the content to a wireless transmit/receive unit (WTRU) more readily than the second storage subsystem.

8. The network of claim 7, wherein on a condition that a popularity associated with the content decreases below a threshold, the entry server is further configured to move the content to the second storage subsystem.

9. The network of claim 1, wherein the first storage subsystem is able to provide the content to a wireless transmit/receive unit (WTRU) less readily than the second storage subsystem.

10. The network of claim 1, wherein on a condition that a popularity associated with the content increases above a threshold, the entry server is further configured to move the content to the second storage subsystem.

11. The network of claim 1, wherein the first storage subsystem is a caching subsystem.

12. The network of claim 1, wherein the second storage subsystem is a P2P subsystem.

13. A network for facilitating delivery of content, the network comprising:
a first storage subsystem utilizing a first storage technology;
a second storage subsystem utilizing a second storage technology;
an entry server configured to receive a request for ingestion of the content; and
the entry server further configured to determine to store the content in one of the first storage subsystem or the second storage subsystem based on an attribute associated with the content.

14. The network of claim 13, wherein the first storage subsystem is capable of providing the content to a wireless transmit/receive unit (WTRU) more readily than the second storage subsystem.

15. The network of claim 14, wherein on a condition that a popularity associated with the content is greater than a threshold, the entry server is further configured to determine to store the content in the first storage subsystem.

16-19. (canceled)

20. The network of claim 13, wherein the attribute associated with the content is a popularity of the content.

21. The network of claim 11, wherein a determination to store the content in the first storage subsystem facilitates expedient delivery of the content if the content is popular and a determination to store the content in the second storage subsystem reserves storage in at least the first storage subsystem if the popularity is low and adjusting the storage of the content within the first storage subsystem and the second storage subsystem using a popularity metric associated with the content.
